(19) United States
(12) Patent Application Publication
(10) Pub. No.: US 2020/0321570 A1
(43) Pub. Date: Oct. 8, 2020

(54) Battery Pack

(71) Applicant: Marelli Corporation, Saitama-shi, Saitama (JP)

(72) Inventors: Toshiyuki Motohashi, Saitama-shi, Saitama (JP); Takayuki Hirase, Saitama-shi, Saitama (JP)

(21) Appl. No.: 16/753,515

(22) PCT Filed: Oct. 1, 2018
(86) PCT No.: PCT/JP2018/036718

§ 371 Date: Apr. 3, 2020

(30) Foreign Application Priority Data
Oct. 3, 2017 (JP) 2017-193802

(51) Int. Cl. H01M 2/10; H01M 2/34; H01M 10/42; H01M 2/20; H01M 2/02

(52) U.S. Cl. CPC H01M 2/1077; H01M 2/34; H01M 2/0257; H01M 2/1061; H01M 2/206; H01M 10/425

(57) ABSTRACT

A battery pack includes stacked battery cells housed between a first case and a second case. The battery cells each include electrode tabs protruding from an outer surface. The first case and the second case are aligned in a direction in which the electrode tabs protrude and are connected to each other. The battery cells are inserted in the first case in the direction in which the electrode tabs protrude. The first case includes an abutting portion against which the electrode tab or the outer surface of each of the battery cells abuts in the direction in which the electrode tabs protrude.

### CROSS-REFERENCE TO RELATED APPLICATION

The present application is a 371 of International Application Serial No. PCT/JP2018/036718, filed Oct. 1, 2018, which claims priority to and the benefit of Japanese Patent Application No. 2017-193802 filed Oct. 3, 2017, the entire contents of which are incorporated herein by reference.

### TECHNICAL FIELD

The present disclosure relates to a battery pack.

### BACKGROUND

A chargeable/dischargeable battery module that includes a plurality of battery cells is known. For example, patent literature JP5154454B2 discloses a battery module in which a plurality of battery cells are arranged inside an upper frame and lower frame that are joined together.

### SUMMARY

In the battery module disclosed in JP5154454B2, however, the outer surface of the battery cell on which an electrode tab is formed differs from the outer surface of the battery cell for positioning the battery cell in the lower frame. If the electrode tabs of adjacent battery cells are welded after positioning the battery cells in the lower frame in this case, it might not be possible to secure sufficient accuracy for positioning the electrode tabs.

The present disclosure has been conceived from this perspective and aims to provide a battery pack capable of positioning electrode tabs inside a case.

To resolve the aforementioned problem, a battery pack according to an embodiment of the present disclosure includes a stacked plurality of battery cells housed between a first case and a second case;

wherein the battery cells each include an electrode tab protruding from an outer surface of an exterior member;

wherein tips of adjacent electrode tabs are connected by being bent in opposite directions to be folded and overlap with each other;

wherein the first case and the second case are aligned in a direction in which the electrode tab protrudes and are connected to each other;

wherein the exterior member of each battery cell is inserted in the first case in the direction in which the electrode tab protrudes, and is supported by the first case;

wherein the first case includes an inner wall intersecting the direction in which the electrode tab protrudes;

wherein the inner wall is positioned farther outward, at a folded and overlapping portion of the electrode tabs, than the tip of the electrode tab disposed at one side in a stacking direction of the battery cells and abuts against the tip of the electrode tab disposed at the other side in the stacking direction of the battery cells to regulate movement of the electrode tabs at the one side and the other side;

wherein the folded and overlapping portion of the electrode tabs is welded; and

wherein an opening is formed on the inner wall to expose a welding spot of the electrode tabs.

An embodiment of the present disclosure can provide a battery pack capable of positioning electrode tabs inside a case.

### BRIEF DESCRIPTION OF THE DRAWINGS

In the accompanying drawings:

FIG. 1 is a perspective view illustrating the appearance of a battery pack according to a first embodiment of the present disclosure;

FIG. 2 is an exploded perspective view of each component inside the battery pack in FIG. 1;

FIG. 3A is a top view of a battery cell;

FIG. 3B is a side view of a battery cell;

FIG. 4A is a perspective view, from the top, of a restraining plate;

FIG. 4B is a cross-sectional view along the I-I line of FIG. 4A;

FIG. 5A is a perspective view, from the top, illustrating an enlargement of a portion of the front surface of a first case;

FIG. 5B is a perspective view from the back of the first case and illustrates an enlargement of two portions surrounded by a dashed line;

FIG. 5C is a back view of the first case and illustrates an enlargement of the portion thereof surrounded by a dashed line;

FIG. 5D schematically illustrates an example of the positional relationships between an abutting portion of the first case and a battery cell;

FIG. 6A is a perspective view, from the top, illustrating an enlargement of a portion of the back surface of a second case;

FIG. 6B is a perspective view from the back of the second case and illustrates an enlargement of two portions surrounded by a dashed line;

FIG. 6C is a back view of the second case and illustrates an enlargement of the portion thereof surrounded by a dashed line;

FIG. 7A is a schematic diagram illustrating a representative first step for assembling a battery pack;

FIG. 7B is a schematic diagram illustrating a representative second step for assembling a battery pack;

FIG. 7C is a schematic diagram illustrating a representative third step for assembling a battery pack;

FIG. 7D is a schematic diagram illustrating a representative fourth step for assembling a battery pack;

FIG. 8A illustrates an enlargement of a portion of a cross-section along the II-II line of FIG. 7C;

FIG. 8B illustrates an enlargement of a portion of a cross-section along the III-III line of FIG. 7D;

FIG. 9A illustrates an enlargement of a portion R1 surrounded by a dashed line in FIG. 8A;

FIG. 9B illustrates an enlargement of a portion R2 surrounded by a dashed line in FIG. 8A;

FIG. 10A is a perspective view, from the top, illustrating a cross-section of a body supporting a battery pack;

FIG. 10B is a cross-sectional view along the IV-IV line of FIG. 10A;

FIG. 10C illustrates an enlargement of the portion surrounded by a dashed line in FIG. 10B;

FIG. 11A illustrates a completed battery pack according to a second embodiment of the present disclosure;

FIG. 11B is an exploded perspective view of the assembled battery in FIG. 11A;

FIG. 12 a top view illustrating only the battery cell of FIGS. 11A and 11B;

FIG. 13A is a perspective view, from the back, of a first case of FIG. 11B and illustrates an enlargement of the portion thereof surrounded by a dashed line;

FIG. 13B is a back view of the first case of FIG. 11B and illustrates an enlargement of the portion thereof surrounded by a dashed line;

FIG. 14 is a perspective view illustrating the appearance of a battery pack according to a third embodiment of the present disclosure;

FIG. 15A is an external perspective view of the battery pack illustrating a fitting portion of a first case and a second case; and

FIG. 15B illustrates an enlargement of the portion surrounded by a dashed line in FIG. 15A.

### DETAILED DESCRIPTION

Embodiments of the present disclosure are described below with reference to the attached drawings. The front-back, left-right, and up-down directions in the description below take the directions of the arrows in the figures as a reference. The stacking direction of the plurality of battery cells 10 in the example below is the up-down direction, but this example is not limiting. The stacking direction of the plurality of battery cells 10 may match any other direction.

### First Embodiment

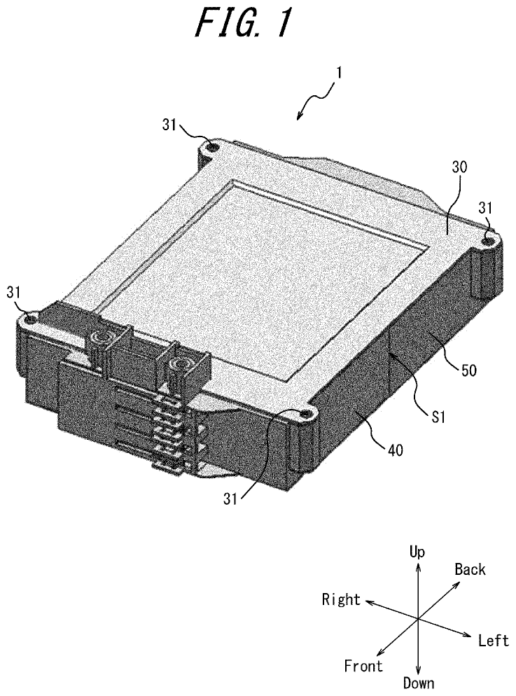

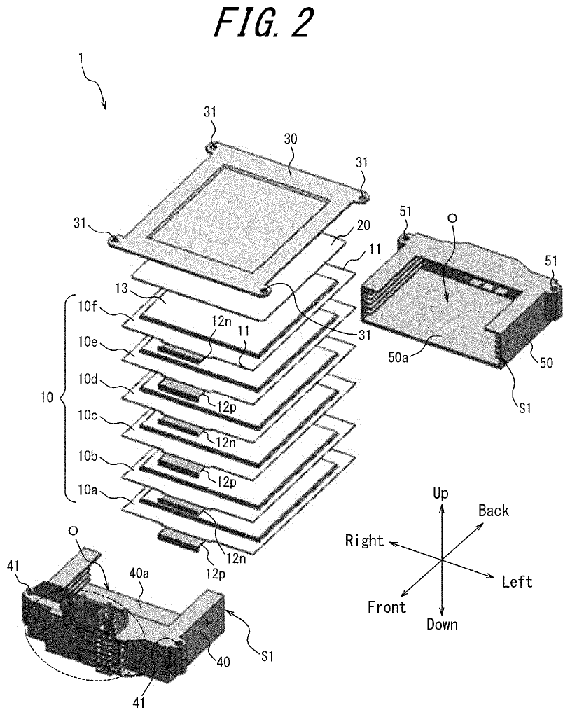

FIG. 1 is a perspective view illustrating the appearance of a battery pack 1 according to a first embodiment of the present disclosure. FIG. 2 is an exploded perspective view of each component inside the battery pack 1 illustrated in FIG. 1. The battery pack 1 includes six battery cells 10, an insulating sheet 20, a restraining plate 30, a first case 40, and a second case 50 as major constituent elements.

The six battery cells 10 are stacked in the up-down direction. The six stacked battery cells 10 are referred to below as the battery cells 10a, 10b, 10c, 10d, 10e, 10f in order from bottom to top. The battery cells are referred to collectively as battery cells 10 when no distinction therebetween is made. Each battery cell 10 has two outer surfaces 11 formed by a front surface and a back surface that are substantially parallel in the up-down direction. Each battery cell 10 has one pair of electrode tabs 12p and 12n that protrude in opposite directions from the two outer surfaces 11 in a direction substantially perpendicular to the stacking direction, in particular in the front-back direction. Each battery cell 10 is stacked with the pair of electrode tabs 12p and 12n aligned in the front-back direction.

The insulating sheet 20 is formed as a substantially flat plate by an electrically insulating material such as polyethylene (PE) or polypropylene (PP) resin. The insulating sheet 20 is disposed to abut against the upper surface of the battery cell 10f positioned at the top of the stacked battery cells 10. The insulating sheet 20 is provided to secure electrical insulation between the restraining plate 30 abutting against the upper surface of the battery pack 1 and the battery cells 10 inside the battery pack 1.

The restraining plate 30 is disposed to abut against the upper surface of the insulating sheet 20. The restraining plate 30 is fixed to the upper surfaces of the engaged first case 40 and second case 50 by a suitable method, such as screwing. For example, the restraining plate 30 is fixed to the top of the engaged first case 40 and second case 50 by screwing screws into hole portions 31 provided at the four corners of the restraining plate 30 and aligned with two screw holes 41 provided at the left and right front edges of the first case 40 and two screw holes 51 provided at the left and right back edges of the second case 50. The restraining plate 30 clamps the battery cells 10 to the first case 40 and the second case 50 in a state that restrains outer surfaces 13 that are formed by the upper and lower surfaces of the battery cells 10 and that are perpendicular to the stacking direction. At the same time, the restraining plates 30 support the battery cells 10.

The first case 40 and the second case 50 engage with each other to support the stacked battery cells 10 therein. The stacked plurality of battery cells 10 are housed between the first case 40 and the second case 50. The stacked battery cells 10 are mounted on a bottom surface 40a of the first case 40 and a bottom surface 50a of the second case 50. When engaged, the first case 40 and the second case 50 have an opening O formed on the top surface opposite the bottom surface. Connection surfaces S1 of the first case 40 and the second case 50 that are connected to each other are substantially parallel to the outer surfaces 11 of the battery cells 10 on the electrode tab 12p or 12n side. The connection surfaces Si are parallel to the up-down direction. In this way, the first case 40 and the second case 50 are aligned along the protruding direction of the electrode tabs 12p and 12n of the battery cells 10 and are connected to or separated from each other in this direction.

Among the stacked battery cells 10, adjacent battery cells 10 may be adhesively fixed to each other by an adhesive such as a bonding agent or double-sided tape. For example, adjacent battery cells 10 may be adhesively fixed to each other by any method, such as applying a bonding agent to the upper surface of each battery cell 10. Similarly, the battery cell 10f and the insulating sheet 20 may be adhesively fixed to each other by adhesive. The insulating sheet 20 and restraining plate 30 may also similarly be adhesively fixed to each other by adhesive.

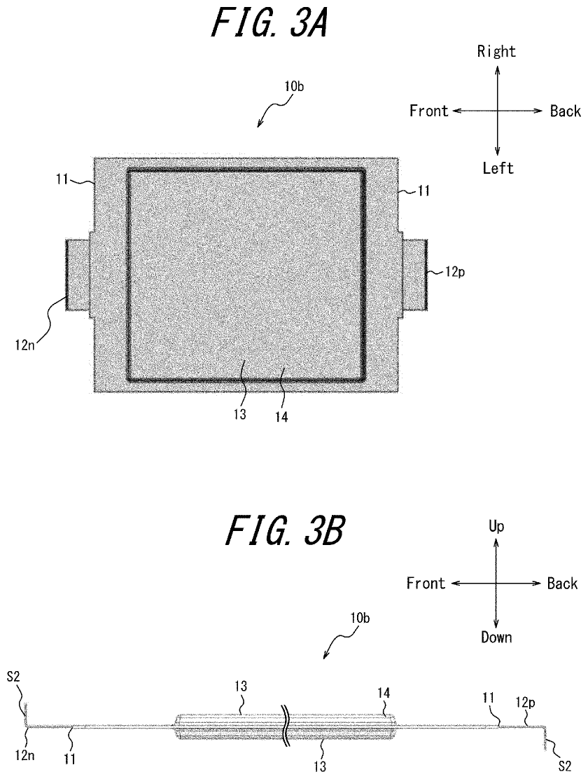

FIGS. 3A and 3B illustrate only the battery cell 10 of FIG. 2. FIG. 3A is a top view of the battery cell 10. FIG. 3B is a side view of the battery cell 10. As an example, FIGS. 3A and 3B illustrate the battery cell 10b disposed as in FIG. 2. The other battery cells 10 are also configured similarly to the battery cell 10b illustrated in FIGS. 3A and 3B.

The battery cell 10 is formed as a substantially flat plate when viewed from the top. An exterior member 14 of the battery cell 10 is formed by a laminated film. The outermost layer of the exterior member 14 is made of resin to secure electrical insulation. The upper and lower surfaces of the exterior member 14 form the outer surfaces 13. The outer surfaces 11 protrude one step farther outward in the central region than at the left and right edges. The outer surfaces 11 are formed to be convex when viewed from the top. The electrode tab 12p or 12n protrudes from the portion of the outer surface 11 that protrudes one step outward. The electrode tabs 12p and 12n normally protrude as a flat plate but are symmetrically bent towards the outside to be substantially L-shaped, when viewed from the side, in order to contact the electrode tab of another battery cell 10 adjacent in the up-down direction and the like. For example, the electrode tab 12p protrudes linearly outward along the front-back direction and then bends downwards. The electrode tab 12n protrudes linearly outward along the front-back direction and then bends upwards. In the example below, the electrode tab 12p bent downwards is a positive electrode terminal, and the electrode tab 12n bent upwards is a negative electrode terminal, but this example is not limiting. The electrode tabs 12p and 12n may be configured so that the positive electrode and negative electrode roles are reversed.

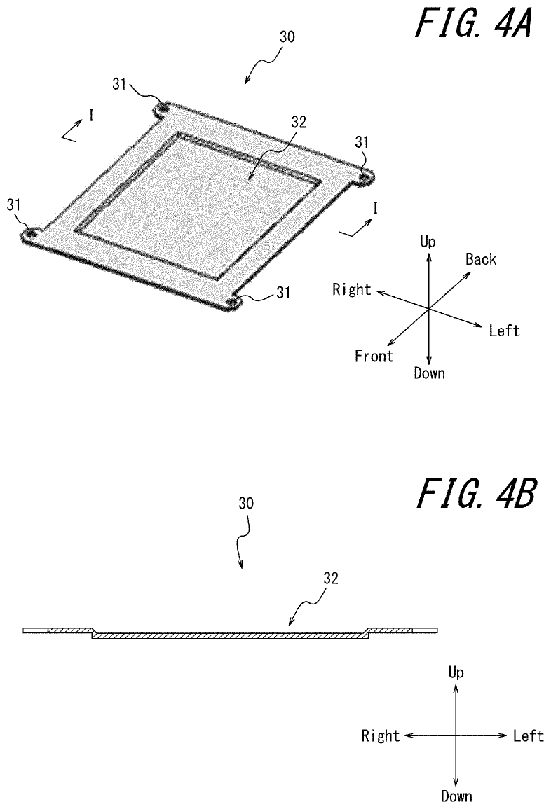

FIGS. 4A and 4B illustrate only the restraining plate 30 of FIG. 2. FIG. 4A is a perspective view, from the top, of the restraining plate 30. FIG. 4B is a cross-sectional view along the I-I line of FIG. 4A.

The restraining plate 30 is made of any highly rigid material. For example, the restraining plate 30 may be made exclusively of a metal material. This example is not limiting, and the restraining plate 30 may be made of a resin material or a metal material provided with an electrically insulating material, such as PET resin, on the surface thereof. The restraining plate 30 is formed as a substantially flat plate. The restraining plate 30 has a substantially rectangular recess 32 formed at the substantially central region and recessed one step inward along the up-down direction. Four hole portions 31 protrude from the four corners of the outer edge of the restraining plate 30 that surrounds the recess 32. The surface of the recess 32 is, for example, formed linearly to be substantially parallel to the surface of the outer edge of the restraining plate 30. The surface of the recess 32 is not limited to this configuration and may, for example, be formed as a linear or curved surface that is inclined to protrude farther inward towards the central region thereof. The battery pack 1 can firmly fix the battery cells 10 therein by pressure from the recess 32. The restraining plate 30 is not limited to a configuration such as the recess 32. For example, the recess 32 may be omitted, and the restraining plate 30 may be formed so that the surface thereof is a linear or curved surface inclined to protrude gradually inward from the outer edge towards the central region thereof. Instead of the recess 32, the restraining plate 30 may have at least one rib that protrudes from the lower surface in the central region, for example.

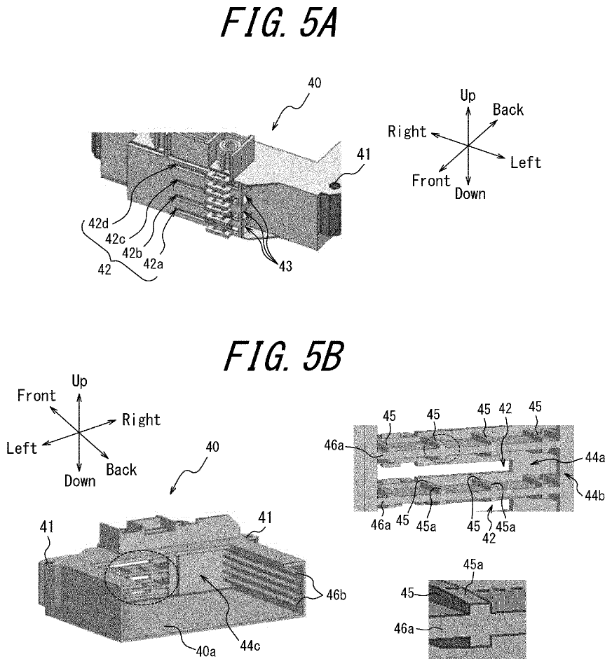

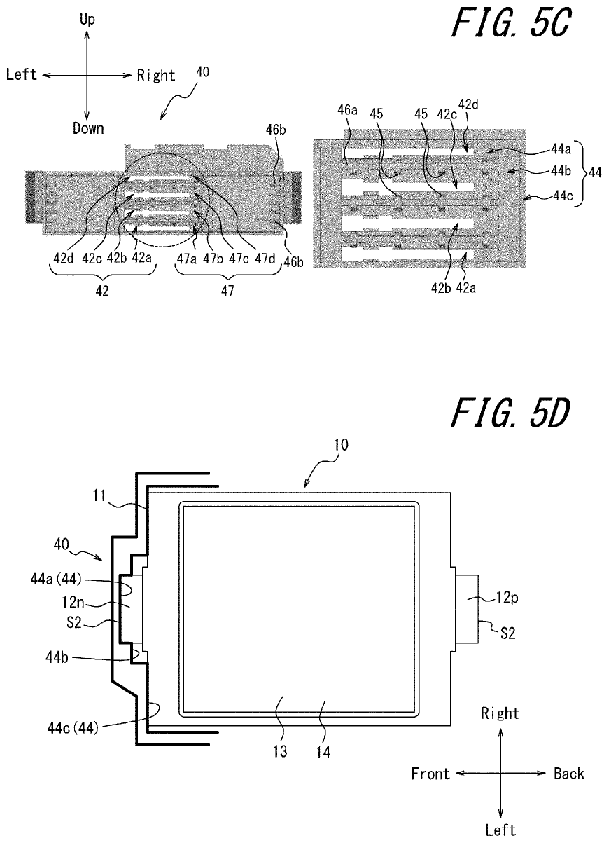

FIGS. 5A through 5C illustrate only the first case 40 of FIG. 2. FIG. 5A is a perspective view, from the top, illustrating an enlargement of a portion of the front surface of the first case 40. FIG. 5B is a perspective view from the back of the first case 40 and illustrates an enlargement of two portions surrounded by a dashed line. FIG. 5C is a back view of the first case 40 and illustrates an enlargement of the portion thereof surrounded by a dashed line. FIG. 5D schematically illustrates an example of the positional relationships between an abutting portion 44 of the first case 40 and the battery cell 10.

The first case 40 is made of a resin material or a metal material provided with an electrically insulating material, such as PET resin, on the surface thereof. The first case 40 may be made of any highly rigid material. The central region on the front surface of the first case 40 is formed to protrude one step outward. Four substantially rectangular windows 42 that pass through the front surface extend in the left-right direction in the central region of the front surface. One half of each window 42 in the left-right direction is formed to be wider in the up-down direction than the other half. Each window 42 is formed to be smaller than a tip surface S2 of the electrode tabs 12p and 12n of the battery cell 10. The tip surface S2 of the electrode tabs 12p and 12n is the outer surface of the portion of each tab bent in the up-down direction (see FIG. 3B). The four windows 42 are arranged in a line in the up-down direction so that the positions of the left and right ends and the positions of the wide halves in the left-right direction are aligned. Jig insertion holes 43 are formed on the left and right side surfaces of the central region on the front surface of the first case 40. A pair of jig insertion holes 43 is formed in correspondence with each of the four windows 42 at substantially the same height position as each window 42. The jig insertion holes 43 of each pair are formed to be at substantially the same height position on the left and right sides of the front central region of the first case 40.

For example, as illustrated in FIG. 5D, the first case 40 includes an abutting portion 44 against which the electrode tab 12p or 12n, or the outer surface 11, of each battery cell 10 abuts in the direction in which the electrode tabs 12p and 12n protrude. The abutting portion 44 abuts against the electrode tab 12p or 12n that protrudes from the outer surface 11, or abuts against the outer surface 11, of the battery cell 10 inserted into the first case 40 along the direction in which the electrode tabs 12p and 12n protrude. The abutting portion 44 is, for example, configured by the inner wall of the surface that intersects the direction in which the electrode tabs 12p and 12n protrude. The abutting portion 44 is, for example, configured by a first inner wall 44a of the first case 40 faced by the electrode tab 12p or 12n of the battery cell 10 when the battery cell 10 is inserted into the first case 40. The first inner wall 44a is configured by the surface on which the windows 42 are formed within the back surface of the front central region of the first case 40. In this case, the tip surface S2 of the electrode tab 12p or 12n abuts against the first inner wall 44a when the six battery cells 10 are inserted in the first case 40.

The first case 40 includes a second inner wall 44b positioned at the back side of the jig insertion holes 43 and formed one step inward from the first inner wall 44a. As illustrated in FIG. 5D, for example, the second inner wall 44b is separated from the battery cell 10 and need not be part of the abutting portion 44. This configuration is not limiting, and the abutting portion 44 may be configured by the second inner wall 44b. In this case, when the six battery cells 10 are inserted in the first case 40, the central region protruding one step farther outward than at the left and right edges on the outer surface 11 may abut against the second inner wall 44b.

The first case 40 includes a third inner wall 44c formed one step farther inward than the second inner wall 44b. The abutting portion 44 may be configured by the third inner wall 44c. In this case, when the six battery cells 10 are inserted in the first case 40, the left and right edges that are recessed one step farther inward than the central region on the outer surface 11 abut against the third inner wall 44c.

In this way, each battery cell 10 is positioned by abutting the corresponding portion against the abutting portion 44 of the first case 40, using the electrode tab 12p or 12n, or the outer surface 11, as a reference. The abutting portion 44 is positioned near the windows 42. In greater detail, the abutting portion 44 is formed in the first case 40 to be at the same position on the front edge as the front central region where the windows 42 are formed. This configuration enables accurate positioning in the battery pack 1 when the electrode tabs 12p and 12n of adjacent battery cells 10 are welded together.

The first case 40 further includes guides 45, protruding inward from the first inner wall 44a, that guide the pair of electrode tabs 12p and 12n towards the first inner wall 44a and the below-described housing portion 47 when the battery cell 10 is inserted. At least one guide 45 is provided to protrude from the first inner wall 44a. The first case 40 further includes first insulating portions 46a, protruding inward from the first inner wall 44a, for electrically insulating electrode tabs 12p and 12n that are adjacent in the stacking direction of the battery cells 10 from each other. A total of three first insulating portions 46a are provided, one between each of the four windows 42. The front-back position of the back end of the first insulating portions 46a is the same as the second inner wall 44b. The back surface of the first insulating portions 46a and the second inner wall 44b are coplanar. The first insulating portions 46a are formed to be plate-shaped along the electrode tabs 12p and 12n.

Each guide 45 is formed as a rib extending along the front-back direction on the upper and lower surfaces of the first insulating portions 46a and protrudes in the up-down direction. For example, four guides 45 are provided on the upper surface of each first insulating portion 46a. These guides 45 are separated in the left-right direction at equal intervals. Similarly, four guides 45 are provided on the lower surface of each first insulating portion 46a. These guides 45 are separated in the left-right direction at equal intervals. The guides 45 formed on the upper and lower surfaces of the first insulating portions 46a may be disposed at the same positions or different positions in the left-right direction.

The guide 45 may include a tapered portion 45a such that the amount of protrusion decreases in the direction moving inward from the first inner wall 44a. For example, the amount of protrusion from the first insulating portion 46a may be constant in the first half of the guide 45 and then gradually decrease, starting at the substantially central region, towards the inside in the second half of the guide 45. The tapered shape of the tapered portion 45a may, for example, be linear or be a gradual curve. In this way, the separation width between adjacent guides 45 separated in the up-down direction increases towards the inside. This configuration of the tapered portion 45a enables the battery pack 1 to further improve the ease of insertion of the battery cells 10 into the first case 40.

The first case 40 includes four housing portions 47 therein. The back portion of the front central region, which protrudes one step outward, is divided in the up-down direction into the four housing portions 47 by the three first insulating portions 46a. Each housing portion 47 houses the electrode tabs 12p and 12n arranged at the corresponding position in the up-down direction. The four housing portions 47 are referred to below as the housing portions 47a, 47b, 47c, and 47d in order from bottom to top. The housing portions are referred to collectively as housing portions 47 when no distinction therebetween is made. One window 42 is disposed at the front end of each of the housing portions 47a to 47d.

The first case 40 includes second insulating portions 46b protruding inward from the inner surface at both sides in the left-right direction. The second insulating portions 46b insulate adjacent battery cells 10 from each other when the battery cells 10 are stacked. A total of five second insulating portions 46b are provided, for example, one between each of the six stacked battery cells 10. The second insulating portions 46b are, for example, lined up in the stacking direction of the six battery cells 10, i.e. the up-down direction, at the same front-back position and with the same front-back width. The second insulating portions 46b also function as guides when the battery cells 10 are inserted into the first case 40.

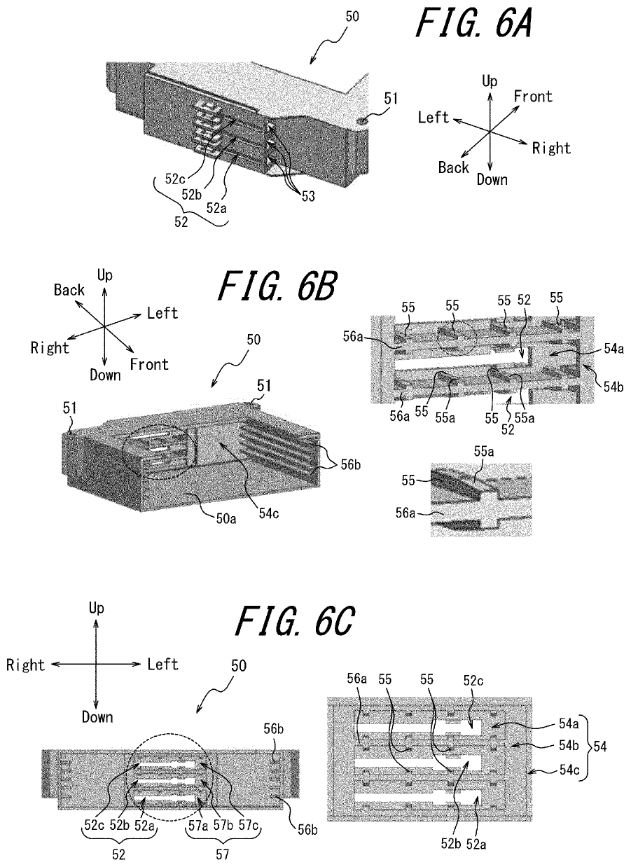

FIGS. 6A through 6C illustrate only the second case 50 of FIG. 2. FIG. 6A is a perspective view, from the top, illustrating an enlargement of a portion of the back surface of the second case 50. FIG. 6B is a perspective view from the back of the second case 50 and illustrates an enlargement of two portions surrounded by a dashed line. FIG. 6C is a back view of the second case 50 and illustrates an enlargement of the portion thereof surrounded by a dashed line.

The second case 50 is configured similarly to the first case 40 and includes screw holes 51, windows 52, jig insertion holes 53, a first inner wall 54a, a second inner wall 54b, a third inner wall 54c, guides 55, tapered portions 55a, first insulating portions 56a, second insulating portions 56b, and housing portions 57. The above explanation of the first case 40 similarly applies to the corresponding components of the second case 50. The second case 50 is described below, focusing on the differences from the first case 40.

Three windows 52 in the second case 50 are formed to be located in the up-down direction between the corresponding windows 42 of the first case 40. In greater detail, the four windows 42 are referred to as windows 42a, 42b, 42c, and 42d in order from bottom to top, and the three windows 52 are referred to as windows 52a, 52b, and 52c in order from bottom to top. In this case, the window 52a is positioned between the window 42a and the window 42b in the up-down direction. The window 52b is positioned between the window 42b and the window 42c in the up-down direction. The window 52c is positioned between the window 42c and the window 42d in the up-down direction.

For example, the wide halves of the windows 52 may be formed on the same side in the left-right direction as the wide halves of the windows 42. When the wide halves of the windows 42 are formed on the left side, for example, as illustrated in FIG. 5C, the wide halves of the windows 52 may be formed on the left side, as illustrated in FIG. 6C.

A total of two first insulating portions 56a are provided, one between each of the three windows 52. The back portion of the back central region, which protrudes one step outward, is divided in the up-down direction into three housing portions 57 by the two first insulating portions 56a. Each housing portion 57 houses the electrode tabs 12p and 12n arranged at the corresponding position in the up-down direction. The three housing portions 57 are referred to below as the housing portions 57a, 57b, and 57c in order from bottom to top. The housing portions are referred to collectively as housing portions 57 when no distinction therebetween is made. The guides 55 are similarly provided on the bottom surface of the housing portion 57a and the ceiling surface of the housing portion 57c. For example, four guides 55 are provided on these surfaces.

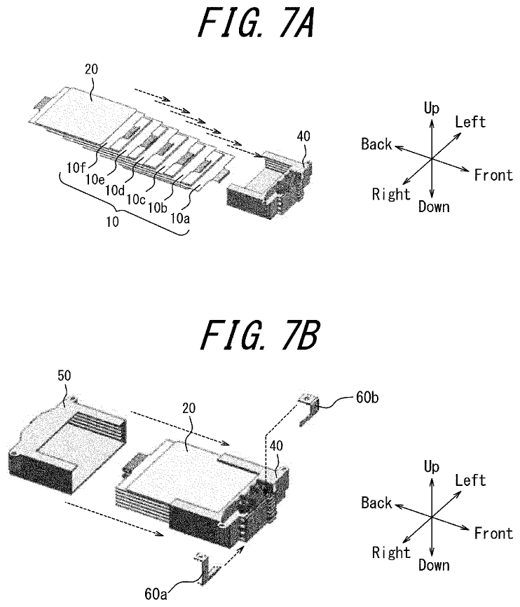

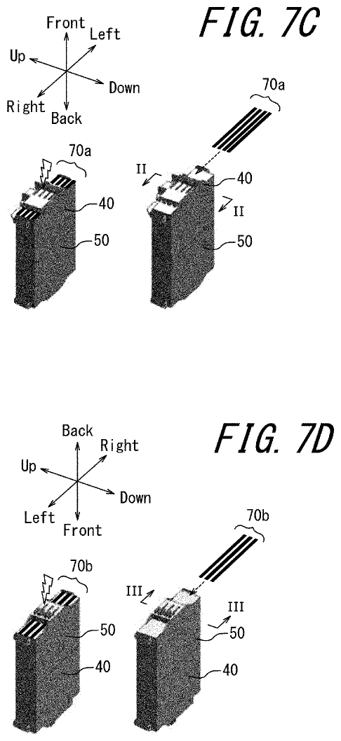

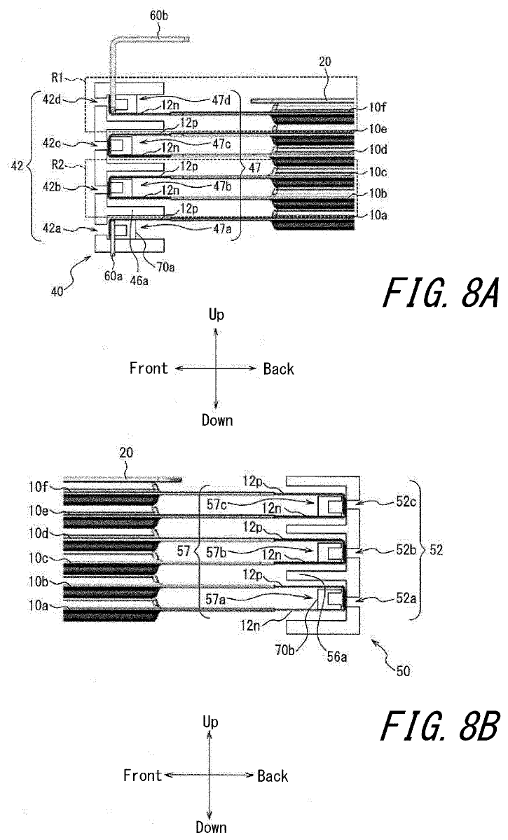

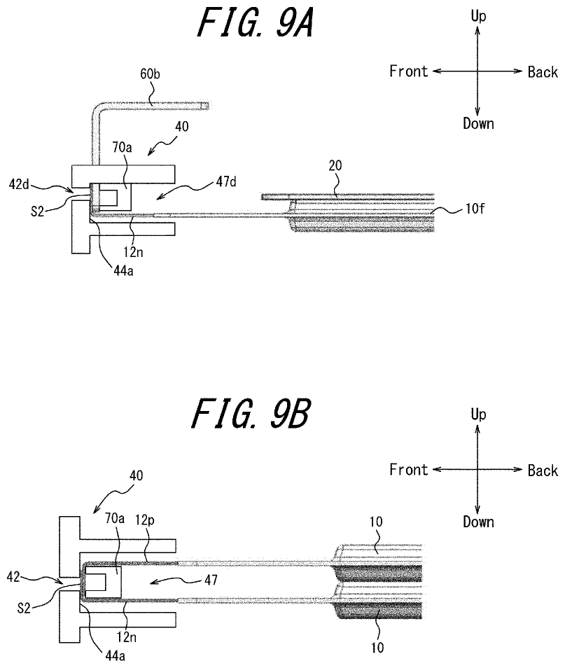

FIGS. 7A through 7D are schematic diagrams illustrating the steps for assembling the battery pack 1. FIGS. 7A through 7D are schematic diagrams respectively illustrating representative first through fourth steps for assembling the battery pack 1. FIGS. 8A and 8B are schematic diagrams illustrating the inside of the first case 40 and the second case 50 at the time of the third and fourth steps of FIGS. 7C and 7D. FIG. 8A illustrates an enlargement of a portion of a cross-section along the II-II line of FIG. 7C. FIG. 8B illustrates an enlargement of a portion of a cross-section along the line of FIG. 7D. FIGS. 9A and 9B illustrate an enlargement of the portion surrounded by a dashed line in FIG. 8A. FIG. 9A illustrates an enlargement of the portion R1 surrounded by a dashed line in FIG. 8A. FIG. 9B illustrates an enlargement of the portion R2 surrounded by a dashed line in FIG. 8A.

In the first step illustrated in FIG. 7A, six battery cells 10 to be stacked and the insulating sheet 20 are inserted in order one at a time from the bottom into the first case 40. The six battery cells 10 are inserted in the first case 40 with the electrode tabs 12p and 12n having been bent. At this time, each battery cell 10 is positioned by the corresponding portion abutting against the abutting portion 44 of the first case 40, using the electrode tab 12p or 12n, or the outer surface 11, as a reference. Within the battery cell 10, the outer surface 11 on which the electrode tab 12p or 12n is formed is used to position the battery cell 10, in particular the electrode tab 12p or 12n, with respect to the first case 40. In the second step illustrated in FIG. 7B, the second case 50 is fitted from behind onto the first case 40 that holds the battery cells 10 and the insulating sheet 20. At the same time, a total plus bus bar 60a and a total minus bus bar 60b are fixed temporarily to the first case 40. In the third step illustrated in FIG. 7C, a corresponding jig 70a is inserted into the jig insertion holes 43 of the first case 40 to fix the electrode tabs 12p and 12n inside the first case 40. The electrode tabs 12p and 12n are, for example, fixed by the jig 70a to abut against the first inner wall 44a. Subsequently, the electrode tabs 12p and 12n, the electrode tab 12p and the total plus bus bar 60a, and the electrode tab 12n and the total minus bus bar 60b are welded by an appropriate method, such as laser welding. The laser used in the case of laser welding, for example, irradiates welding spots through the windows 42. In the fourth step illustrated in FIG. 7D, a corresponding jig 70b is inserted into the jig insertion holes 53 of the second case 50 to fix the electrode tabs 12p and 12n. Subsequently, the electrode tabs 12p and 12n are welded together by an appropriate method, such as laser welding. The laser used in the case of laser welding, for example, irradiates welding spots through the windows 52.

The restraining plate 30 is fixed to the upper surfaces of the engaged first case 40 and second case 50 by a suitable method, such as screwing, after the fourth step illustrated in FIG. 7D. This completes the assembly of the battery pack 1.

By the aforementioned steps, the electrode tabs 12p and 12n of the battery cells 10 are housed in the housing portions 47 of the first case 40 and the housing portions 47 of the second case 50, as illustrated in FIGS. 8A and 8B. In this state, the six battery cells 10 are stacked so that the electrode tabs 12p and 12n of adjacent battery cells 10 are arranged alternately at the front and back.

For example, the electrode tab 12p of the battery cell 10a is disposed in the housing portion 47a, as illustrated in FIG. 8A. The electrode tab 12n of the battery cell 10b adjacent to the upper portion of the battery cell 10a is disposed in the housing portion 47b. Similarly, the electrode tab 12p of the battery cell 10c adjacent to the upper portion of the battery cell 10b is disposed in the housing portion 47b. The electrode tabs 12p and 12n at the front of the battery cells 10d, 10e, and 10f are similarly arranged alternately in the housing portions 47c and 47d. Consequently, one, two, two, and one electrode tabs are respectively housed in the four housing portions 47 of the first case 40 from bottom to top, with the electrode tabs 12p and 12n being arranged alternately.

The first insulating portion 46a is located in the housing portion 47 between the connected pair of electrode tabs 12p and 12n and the electrode tab 12p or 12n of another battery cell 10 adjacent to one of the electrode tabs in the pair of electrode tabs 12p and 12n. The first insulating portion 46a is not, however, located between a pair of electrode tabs 12p and 12n that are connected to each other.

For example, the electrode tab 12n of the battery cell 10a is disposed in the housing portion 57a, as illustrated in FIG. 8B. The electrode tab 12p of the battery cell 10b adjacent to the upper portion of the battery cell 10a is also disposed in the housing portion 57a. The electrode tabs 12p and 12n at the back of the battery cells 10c, 10d, 10e, and 10f are similarly arranged alternately in the housing portions 57b and 57c. Consequently, the electrode tabs 12p and 12n are arranged alternately from bottom to top in the three housing portions 57 of the second case 50. Two electrode tabs 12p and 12n are housed in each housing portion 57.

The first insulating portion 56a is located in the housing portion 57 between the connected pair of electrode tabs 12p and 12n and the electrode tab 12p or 12n of another battery cell 10 adjacent to one of the electrode tabs in the pair of electrode tabs 12p and 12n. The first insulating portion 56a is not, however, located between a pair of electrode tabs 12p and 12n that are connected to each other.

By thus being bent in vertically opposite directions, the electrode tabs 12p and 12n of each battery cell 10 are each connected to the electrode tab of opposite polarity of the adjacent battery cell 10. Ultimately, the six battery cells 10 are connected in series. In greater detail, the battery cells 10 with the first insulating portion 46a disposed between the electrode tabs 12p and 12n are connected to each other by electrode tabs 12n and 12p of different polarity than the polarity of the electrode tabs 12p and 12n with the first insulating portion 46a therebetween. For example, the battery cell 10a and the battery cell 10b are connected to each other at the second case 50 side by electrode tabs 12n and 12p of different polarity from the polarity of the electrode tabs 12p and 12n with the first insulating portion 46a therebetween. Put the other way around, the first insulating portion 46a is provided between electrode tabs 12p and 12n of different polarity from the connected polarity with regard to battery cells 10 of a pair of electrode tabs 12n and 12p connected to each other at the second case 50 side.

As illustrated in FIG. 9A, the electrode tab 12n of one battery cell 10f is housed in the top housing portion 47d of the first case 40. The tip of the total minus bus bar 60b is also housed in the housing portion 47d. For example, the tip surface S2 of the electrode tab 12n is opposite the first inner wall 44a, and the back side of this tip surface S2 is opposite the tip of the total minus bus bar 60b. In other words, the first inner wall 44a, the tip of the electrode tab 12n, and the tip of the total minus bus bar 60b are arranged in this order from the outside towards the inside. In this state, when the jig 70a is inserted by the third step illustrated in FIG. 7C, these surfaces abut against each other.

As also illustrated in FIG. 8A, the electrode tab 12p of one battery cell 10a along with the tip of the total plus bus bar 60a are housed in the bottom housing portion 47a of the first case 40. The above explanation with reference to FIG. 9A also applies to the relationship between the electrode tab 12p and the total plus bus bar 60a in the housing portion 47a.

As illustrated in FIG. 9B, the electrode tabs 12p and 12n of two battery cells 10 are housed in overlap in two housing portions 47b and 47c at the center of the first case 40. For example, the tip surface S2 of the electrode tab 12n is opposite the first inner wall 44a, and the back side of this tip surface S2 is opposite the tip surface S2 of the electrode tab 12p. In other words, the first inner wall 44a, the tip of the electrode tab 12n, and the tip of the electrode tab 12p are arranged in this order from the outside towards the inside. In this state, when the jig 70a is inserted by the third step illustrated in FIG. 7C, these surfaces abut against each other.

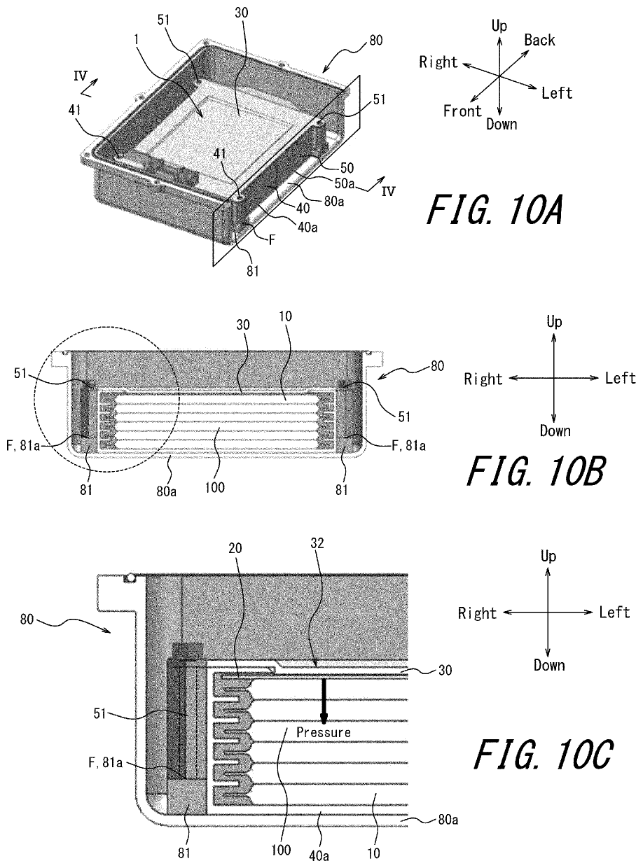

FIGS. 10A through 10C illustrate the battery pack 1 housed in a body 80. FIG. 10A is a perspective view, from the top, illustrating a cross-section of the body 80 supporting the battery pack 1. FIG. 10B is a cross-sectional view along the IV-IV line of FIG. 10A. FIG. 10C illustrates an enlargement of the portion surrounded by a dashed line in FIG. 10B.

The body 80 is configured by a metal material such as aluminum. This configuration is not limiting, and the body 80 may be made of any highly rigid material. For example, the body 80 may be made of a highly rigid resin material or a metal material provided with an electrically insulating material, such as PET resin, on the surface thereof.

The battery pack 1 is fixed to the inside of the body 80 by a suitable method, such as screwing. In greater detail, the battery pack 1 is housed inside the body 80 with the bottom surface 40a of the first case 40 and the bottom surface 50a of the second case 50 abutting against a bottom surface 80a of the body 80. At this time, the bottom surface 80a of the body 80 functions as a restraining member for restraining the stacked battery cells 10 from below, like the upper restraining plate 30. The stacked battery cells 10 are restrained indirectly by the bottom surface 80a as a result of abutting against the bottom surface 40a of the first case 40 and the bottom surface 50a of the second case 50, which abut against the bottom surface 80a. This configuration is not limiting, however. The bottom surface 80a need not abut against the bottom surface 40a of the first case 40 and the bottom surface 50a of the second case 50 if, for example, the bottom surface 40a and the bottom surface 50a themselves can function as a restraining member with sufficient rigidity.

As illustrated in FIGS. 10A through 10C, fixing portions F of the first case 40 and the second case 50 relative to the body 80 are provided farther inward than the bottom surface 80a of the body 80. The fixing portions F are positioned above the bottom surface 80a to be closer to the center of gravity of a battery cell assembly 100 formed by six stacked battery cells 10.

The fixing portions F may, for example, be configured as follows. The two screw holes 41 of the first case 40 may be configured to penetrate from the upper surface to the lower surface of the first case 40, for example. Similarly, the two screw holes 51 of the second case 50 may be configured to penetrate from the upper surface to the lower surface of the second case 50, for example. To support the two screw holes 41 and the two screw holes 51, the body 80 includes supports 81 protruding inward from the bottom surface 80a at corresponding positions. Screw holes 81a are provided on the upper surface of the supports 81. The screws inserted from above through the two screw holes 41 and the two screw holes 51 are screwed into the screw holes 81a. For example, the first case 40 and the second case 50 may be fixed to the body 80 by screws being inserted into the screw holes 41 and the screw holes 51 and screwed into the screw holes 81a. The fixing portion F may be formed by the screw hole 41 or the screw hole 51 together with the screw hole 81a.

In this way, the bottom surface of the battery pack 1 is fixed in a state of abutment against the bottom surface 80a of the body 80. The bottom side of the battery pack 1 is thereby firmly restrained from below by the bottom surface 80a of the body 80. If the top side of the battery pack 1 were only configured by the first case 40, the second case 50, and the insulating sheet 20, then the restraining force would be weaker than at the bottom side. This problem is addressed by the restraining plate 30 being fixed to the first case 40 and the second case 50 to cover the battery cell assembly 100 from one side in the stacking direction, i.e. from above, while the battery pack 1 is fixed to the body 80. As described above, the restraining plate 30 includes the recess 32 that is recessed one step towards the upper surface of the battery cell assembly 100. The insulating sheet 20 is disposed between the restraining plate 30 and the upper surface of the battery cell assembly 100 at this time. The insulating sheet 20 abuts against the recess 32 of the restraining plate 30 and the upper surface of the battery cell assembly 100. On the other hand, the bottom surface 40a of the first case 40 and the bottom surface 50a of the second case 50 abut against the bottom surface 80a of the body 80. The upper surface of the battery cell assembly 100 is pressed from above by the restraining plate 30 while, simultaneously, the lower surface of the battery cell assembly 100 is supported by the bottom surface 80a of the body 80 via the abutment against the bottom surface 40a of the first case 40 and the bottom surface 50a of the second case 50. The position of each battery cell 10 in the up-down direction is thereby regulated. At this time, gas produced inside the battery cells 10 due to deterioration over time tends to collect around the battery cells 10 due to pressure in the stacking direction. The internal gas collects at a location away from the electrodes formed in the central region.

Typically, the battery characteristics of the battery cells 10 and the pressure in the stacking direction of the battery cells 10 are correlated. The electrode spacing inside the battery cells 10 stabilizes when a predetermined pressure is applied. The internal resistance therefore lowers, and the battery characteristics of the battery cells 10 improve. On the other hand, application of excessive pressure impedes the chemical reaction itself inside the battery cell 10, and the battery characteristics worsen. When the battery pack 1 is assembled, the restraining plate 30 is therefore fixed to apply pressure within a predetermined pressure range in order to obtain good battery characteristics that are stable over time. Even if the battery cells 10 swell due to deterioration over time, which by reaction would increase the pressure in the stacking direction of the battery cells 10, an optimal pressure capable of maintaining battery characteristics can still be secured.

The battery pack 1 according to the first embodiment enables accurate positioning when the electrode tabs 12p and 12n of adjacent battery cells 10 are welded together. The electrode tab 12p or 12n, or the outer surface 11, that becomes the reference for positioning and the portion to be welded are disposed near each other. The battery pack 1 thereby enables the electrode tabs 12p and 12n to be positioned more accurately at the time of welding than when the reference for positioning and the portion to be welded are disposed on outer surfaces in different directions of the battery cell. In particular, since the abutting portion 44 is formed by the first inner wall 44a in the battery pack 1, the electrode tab 12p or 12n that serves as the reference for positioning and the portion to be welded can be arranged at substantially the same position. The positioning accuracy of the electrode tabs 12p and 12n is thereby further increased at the time of welding. The battery pack 1 can thus simplify the welding process of the electrode tabs 12p and 12n and facilitate welding operations. Consequently, the battery pack 1 can also contribute to improving product reliability.

The battery pack 1 has improved ease of insertion of the battery cells 10 into the first case 40 and the second case 50 as a result of inclusion of the guides 45 and 55 and the second insulating portions 46b and 56b. This effect is also obtained by a configuration with at least one of the guides 45 and 55 and the second insulating portions 46b and 56b. This effect is most significant when all of these configurations are provided. The battery pack 1 can have further improved ease of insertion when the tapered portions 45a and 55a are provided in the guides 45 and 55. The battery pack 1 can prevent the electrode tabs 12p and 12n from coming into contact with the inner surface of the first case 40 or the second case 50 and deforming at the time of insertion and can reliably house the electrode tabs 12p and 12n in the housing portions 47 and 57. In particular, the formation of the tapered portions 45a and 55a causes the separation width of the guides 45 and 55 in the up-down direction to increase towards the inside, making it easier to avoid interference between the electrode tabs 12p and 12n and the inner wall of the case at the time of insertion. The battery pack 1 can simplify the production process of the first case 40 and the second case 50 by the same number of guides 45 and 55 being provided at the same positions in the left-right direction. The battery pack 1 can contribute to improving productivity.

By provision of the first insulating portions 46a and 56a and the second insulating portions 46b and 56b in the battery pack 1, electrical insulation can be secured between adjacent battery cells 10 in the stacking direction. In addition to the initial state, insulation can also be maintained if the battery cells 10 swell due to deterioration over time, changing the position of the electrode tabs 12p and 12n in the up-down direction.

The first case 40 and the second case 50 in the battery pack 1 are made of a resin material or a metal material provided with an electrically insulating material on the surface thereof. Electrical insulation can thereby be secured between components external to the battery pack 1, such as electrical components, and the battery cells 10 inside the battery pack 1.

The outer surface 13 perpendicular to the stacking direction of the battery cells 10 is restrained by the restraining plate 30 in the battery pack 1. Swelling in the stacking direction of the battery cells 10 can thereby be suppressed if an internal gas is produced during use of the battery pack 1, during charging/discharging, or by deterioration over time. When the restraining plate 30 is made of a metal material, the rigidity thereof increases, and the battery pack 1 can effectively suppress swelling of the battery cells 10. The electrical insulation in the battery pack 1 can also be further improved by forming the restraining plate 30 from a metal material coated with an electrically insulating material or a resin material, like the first case 40 and the second case 50. In this case, the restraining plate 30 can be reduced in weight, and the battery pack 1 can be manufactured at a low cost. This contributes to a reduction in weight and cost of the battery pack 1 itself.

Provision of the insulating sheet 20 and the restraining plate 30 on only one side of the stacked battery cells 10 can reduce the number of components and increase productivity of the battery pack 1. In this way, the battery pack 1 is advantageous in terms of the number of components and productivity as compared to a known battery pack in which a cell cover is provided for each battery cell, for example, to protect the battery cells. The simplified configuration of the battery pack 1 can contribute to improving productivity and reducing costs. By the battery cells 10 being fixed together, the battery cell 10 and the insulating sheet 20 being fixed together, and the insulating sheet 20 and restraining plate 30 being fixed together by adhesive, the resistance of the battery pack 1 to vibration or shock improves. For example, when the battery pack 1 is mounted in a vehicle, the relative displacement between components due to vibration, shock, or the like when the vehicle is moving can be prevented. In this way, the components inside the battery pack 1 are firmly fixed to each other to prevent damage to the internal components from vibration or shock.

The battery pack 1 can achieve a smaller size and a lower profile while suppressing swelling of the stacked battery cells 10. Swelling in the stacking direction of the battery cells 10 can be suppressed in the battery pack 1 by the upper surface of the battery cell assembly 100 being pressed from one side in the stacking direction by the restraining plate 30 while the lower surface is abutted against the bottom surface 40a of the first case 40 and the bottom surface 50a of the second case 50. At the same time, only one restraining plate 30 is used, providing the battery pack 1 with a smaller size, a lower profile, and a lighter weight than a conventional battery module that includes a plurality of restraining plates. Similarly, the battery pack 1 can contribute to reducing the number of components and the cost. The battery cell assembly 100 can be further supported in the battery pack 1 by the bottom surface 40a of the first case 40 and the bottom surface 50a of the second case 50 abutting against the bottom surface 80a of the body 80. In particular, the battery pack 1 includes the restraining plate 30 on the upper surface side, whereas the bottom surface of the battery pack 1 abuts against the bottom surface 80a of the body 80. The battery cell assembly 100 is thereby firmly restrained from both sides in the up-down direction. As a result of the restraint provided by the restraining plate 30 and the bottom surface 80a in the up-down direction, the first case 40 and the second case 50 tend not to warp even when supporting the battery cell assembly 100. In other words, warping of the first case 40 and the second case 50 is regulated by the restraining plate 30 and the bottom surface 80a.

The battery pack 1 can suppress deterioration of the first case 40 and the second case 50 by including the opening O. If the opening O were omitted, and the restraining plate 30 were provided directly on the upper surface of the first case 40 and the second case 50, then the restraining plate 30 would apply pressure directly on these cases, causing the cases to deform and accelerating deterioration. Accordingly, the battery pack 1 can prevent damage to the case due to such degradation over time.

The configuration of the recess 32 of the restraining plate 30 in the battery pack 1 enables suitable application of pressure to the central region of the outer surface 13 of the battery cell 10 that is perpendicular to the stacking direction. The battery pack 1 can thereby further suppress swelling in the stacking direction of the battery cells 10. The application of pressure with the restraining plate 30 enables suitable retention of the battery cell assembly 100 inside the first case 40 and the second case 50, thereby making retention more reliable in the battery pack 1. The battery pack 1 can more firmly fix the battery cell assembly 100 by the pressure from the recess 32. Application of pressure within an optimal range capable of maintaining good battery characteristics in the battery pack 1 can stabilize the internal resistance in the battery cells 10. The pressure in the battery pack 1 releases internal gas from near the electrodes to the outer periphery of the battery cells 10, thereby suppressing degradation of the battery cells 10. The battery pack 1 suppresses the degradation of battery characteristics that occurs when internal gas is present between electrodes. In particular, the battery pack 1 can concentrate more pressure on the central region of the outer surface 13 of the battery cells 10 and more effectively suppress swelling of the battery cells 10 in the stacking direction by the surface of the recess 32 being formed to protrude further inward towards the central region. In this case, the battery pack 1 can more efficiently collect the internal gas at the outer periphery of the battery cells 10.

By the arrangement of the insulating sheet 20, the battery pack 1 can secure electrical insulation between the restraining plate 30 and the internal battery cells 10.

The battery pack 1 can fix the battery cell assembly 100, which is a heavy load, in a balanced manner by the fixing portions F being arranged closer to the center of gravity of the battery cell assembly 100. For example, when the battery pack 1 is mounted in a vehicle, the stress occurring due to vibration, shock, or the like when the vehicle is moving can be relieved. Consequently, the battery pack 1 can contribute to improving product reliability. This arrangement in the battery pack 1 can contribute to lowering the profile.

### Second Embodiment

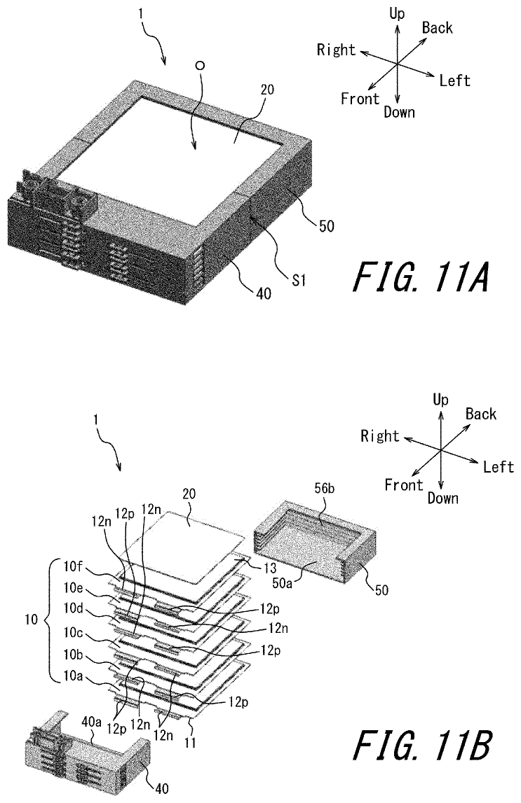

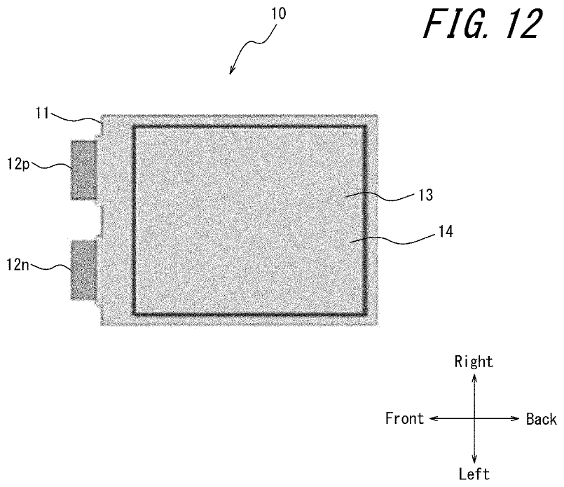

FIGS. 11A and 11B are perspective views illustrating the appearance of a battery pack 1 according to a second embodiment of the present disclosure. FIG. 11A illustrates the completed battery pack 1. FIG. 11B is an exploded perspective view of the battery pack 1. FIG. 12 is a top view illustrating only the battery cell 10 of FIG. 11B. The second embodiment is described as omitting the restraining plate 30 of the battery pack 1 according to the first embodiment, as illustrated in FIGS. 11A and 11B, but the battery pack 1 according to the second embodiment may include the restraining plate 30 like the first embodiment. The battery pack 1 according to the second embodiment differs from the first embodiment in that the electrode tabs 12p and 12n of the battery cell 10 are formed on the same surface. The configuration that is the same as in the first embodiment is labeled with the same reference signs below. A description of this configuration is omitted to focus on the differences from the first embodiment.

As illustrated in FIG. 12, the outer surface 11 of the battery cell 10 protrudes one step farther outward in the central region of each of two halves aligned in the left-right direction than at the left and right edges. The outer surface 11 is formed so that two convex shapes are continuous in the left-right direction when viewed from the top. The electrode tabs 12p and 12n protrude forward from the two portions of the outer surface 11 that protrude one step outward. The electrode tabs 12p and 12n protrude outward symmetrically to be substantially L-shaped. For example, the electrode tab 12p protrudes linearly towards the front and then bends downwards. The electrode tab 12n protrudes linearly towards the front and then bends upwards.

As illustrated in FIG. 11B, six battery cells 10 are stacked so that the positions of the electrode tabs 12p and 12n in the left-right direction differ between adjacent battery cells 10. Specifically, the electrode tab 12p is arranged at the right side and the electrode tab 12n is arranged at the left side on the outer surface 11 of the lowest battery cell 10a. The electrode tab 12n is arranged at the right side and the electrode tab 12p is arranged at the left side on the outer surface 11 of the battery cell 10b that is adjacent to and above the battery cell 10a. The electrode tabs 12p and 12n are also similarly arranged for the battery cells 10c, 10d, 10e, and 10f.

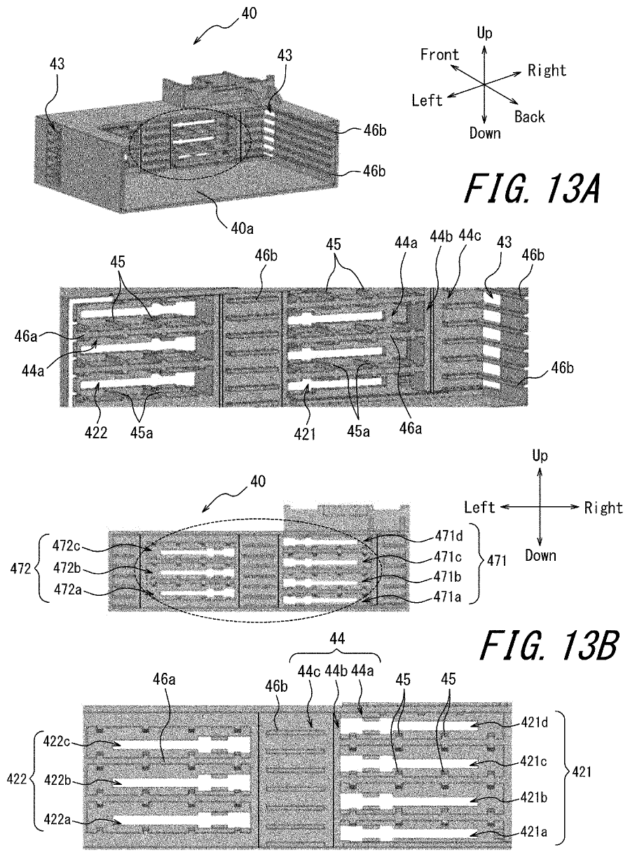

FIGS. 13A and 13B illustrate only the first case 40 of FIG. 11B. FIG. 13A is a perspective view, from the back, of the first case 40 and illustrates an enlargement of the portion thereof surrounded by a dashed line. FIG. 13B is a back view of the first case 40 and illustrates an enlargement of the portion thereof surrounded by a dashed line.

Four substantially rectangular windows 421 that pass through the right half and three substantially rectangular windows 422 that pass through the left half extend on the front surface of the first case 40 in the left-right direction. One half of each window 421 and window 422 in the left-right direction is formed to be wider in the up-down direction than the other half. The four windows 421 are arranged in a line in the up-down direction so that the positions of the left and right ends and the positions of the wide halves in the left-right direction are aligned. Similarly, the three windows 422 are arranged in a line in the up-down direction so that the positions of the left and right ends and the positions of the wide halves in the left-right direction are aligned.

The three windows 422 are formed to be located in the up-down direction between the corresponding windows 421. In greater detail, the four windows 421 are referred to as windows 421a, 421b, 421c, and 421d in order from bottom to top, and the three windows 422 are referred to as windows 422a, 422b, and 422c in order from bottom to top. In this case, the window 422a is positioned between the window 421a and the window 421b in the up-down direction. The window 422b is positioned between the window 421b and the window 421c in the up-down direction. The window 422c is positioned between the window 421c and the window 421d in the up-down direction. For example, the wide half of the windows 421 and the wide half of the windows 422 may be positioned by the central region of the front surface of the first case 40.

The first case 40 includes an abutting portion 44 against which the outer surface 11 of the battery cell 10, or the electrode tabs 12p and 12n protruding from the outer surface 11, abuts. The abutting portion 44 is, for example, configured by a first inner wall 44a of the first case 40 faced by the electrode tabs 12p and 12n of the battery cell 10 when the battery cell 10 is inserted into the first case 40. The first inner wall 44a is configured by the surface on which the windows 421 and 422 are formed within the back side of the front surface of the first case 40. In this case, the tip surface S2 of the electrode tabs 12p and 12n abuts against the first inner wall 44a when the six battery cells 10 are inserted in the first case 40.

The first case 40 includes a second inner wall 44b formed one step farther inward than the first inner wall 44a. The abutting portion 44 may be configured by the second inner wall 44b. In this case, when the six battery cells 10 are inserted in the first case 40, the central region of each of the two halves that protrude one step farther outward than at the left and right edges on the outer surface 11 abuts against the second inner wall 44b.

The first case 40 includes a third inner wall 44c formed one step farther inward than the second inner wall 44b. The abutting portion 44 may be configured by the third inner wall 44c. In this case, when the six battery cells 10 are inserted in the first case 40, the central region and the left and right edges of the outer surface 11, which are recessed one step farther inward than the central regions of the two halves, abut against the third inner wall 44c.

In this way, each battery cell 10 is positioned by abutting the corresponding portion against the abutting portion 44 of the first case 40, using the electrode tabs 12p and 12n, or the outer surface 11, as a reference. The abutting portion 44 is positioned near the windows 421 and 422. In greater detail, the abutting portion 44 is formed in the first case 40 to be at the same position on the front edge as the front central region where the windows 421 and 422 are formed.

The first case 40 further includes guides 45, tapered portions 45a, and first insulating portions 46a configured as in the first embodiment. A total of five first insulating portions 46a are provided, one between each of the four windows 421 and the three windows 422.

The first case 40 includes four housing portions 471 and three housing portions 472 therein. The back side of the left and right halves on the front surface is divided in the up-down direction into the housing portions by three first insulating portions 46a and two first insulating portions 46a respectively. Each housing portion 471 and 472 houses the electrode tabs 12p and 12n arranged at the corresponding position in the up-down direction. The four housing portions 471 are referred to below as the housing portions 471a, 471b, 471c, and 471d in order from bottom to top. The three housing portions 472 are referred to below as the housing portions 472a, 472b, and 472c in order from bottom to top. The housing portions are referred to collectively as housing portions 471 and 472 when no distinction therebetween is made. The windows 421a through 421d are disposed at the front end of the housing portions 471a through 471d. The windows 422a through 422c are disposed at the front end of the housing portions 472a through 472c.

The first case 40 includes second insulating portions 46b protruding inward from the inner surface at both sides in the left-right direction along the third inner wall 44c. The second insulating portions 46b insulate adjacent battery cells 10 from each other when the battery cells 10 are stacked.

Jig insertion holes 43 are formed on the front portion at the left and right side surfaces of the first case 40. A pair of jig insertion holes 43 is formed in correspondence with each of the seven windows 421 and 422 at substantially the same height position as each window 421 and 422.

As illustrated in FIG. 11B, the second case 50 may include second insulating portions 56b that protrude to be substantially C-shaped along the inner surface. The second insulating portions 56b may, for example, be formed only on the left and right side surfaces or only on the back surface. The second insulating portions 56b insulate adjacent battery cells 10 from each other when the battery cells 10 are stacked. The same number of second insulating portions 56b are aligned at the same positions in the up-down direction as the second insulating portions 46b of the first case 40.

The second case 50 may include guides 55 like the first embodiment. In this case, a suitable number of guides 55 are suitably arranged to protrude from at least one of the upper surface and lower surface of the second insulating portions 56b formed on the back surface, for example.

The windows 421 and 422 are concentrated on the front surface in the present embodiment. This makes the fourth step described with reference to FIG. 7D unnecessary when assembling the battery pack 1. After assembly of the battery pack 1 is completed by steps similar to the first step through the third step described with reference to FIG. 7A through FIG. 7C, the electrode tabs 12p and 12n of each battery cell 10 are housed in the housing portions 471 and 472 of the first case 40. In this state, the six battery cells 10 are stacked so that the electrode tabs 12p and 12n of adjacent battery cells 10 are arranged alternately.

For example, the electrode tab 12p of the battery cell 10a and a non-illustrated total plus bus bar 60a are disposed in the housing portion 471a. The electrode tab 12n of the battery cell 10a and the electrode tab 12p of the battery cell 10b adjacent to the upper portion of the battery cell 10 are disposed in the housing portion 472a. Similarly, the electrode tab 12n of the battery cell 10b and the electrode tab 12p of the battery cell 10c adjacent to the upper portion of the battery cell 10b are disposed in the housing portion 47 lb. The electrode tabs 12p and 12n are similarly arranged alternately in the housing portions 472b, 471c, 472c, and 471d. A non-illustrated total minus bus bar 60b is also disposed in the housing portion 471d in addition to the electrode tab 12n of the battery cell 10f.

The above battery pack 1 according to the second embodiment achieves similar effects to those described in the first embodiment. Additionally, the battery pack 1 according to the second embodiment can reduce the number of assembly steps, since the windows 421 and 422 are concentrated on the front surface. The battery pack 1 can thereby contribute to improving productivity. The electrode tabs 12p and 12n of the battery cell 10 are formed only on the outer surface 11, leaving the back of the battery cell 10 flat. The front to back width of the battery cell 10 thus becomes shorter by an amount equal to the electrode tab 12p or 12n. The front to back width of the second case 50 therefore also becomes shorter, and the battery pack 1 can contribute to an overall reduction in size.

### Third Embodiment

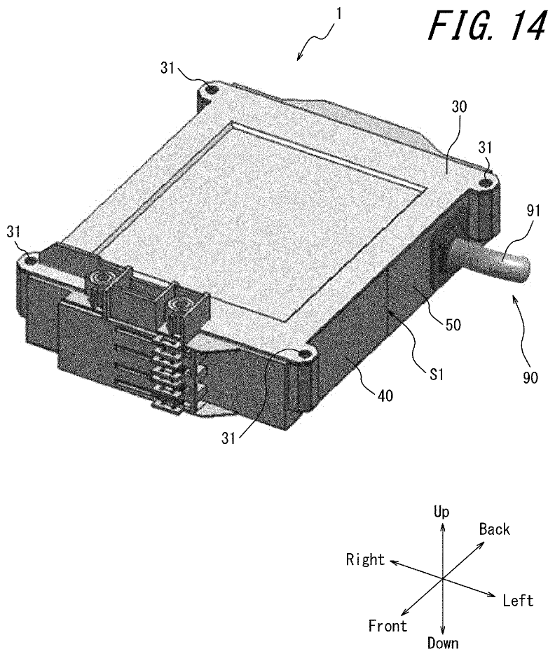

FIG. 14 is a perspective view illustrating the appearance of a battery pack 1 according to a third embodiment of the present disclosure. As illustrated in FIG. 14, the battery pack 1 according to the third embodiment has the configuration of the battery pack 1 according to the first embodiment, with the addition of a discharge portion 90 for discharging gas produced inside the battery cells 10 to the outside. The battery pack 1 may have the configuration of the battery pack 1 according to the second embodiment, with the addition of the discharge portion 90. The configuration that is the same as in the first and second embodiments is labeled with the same reference signs below. A description of this configuration is omitted to focus mainly on the discharge portion 90, which differs from the first and second embodiments.

One discharge portion 90 is provided on the left side surface of the second case 50, for example. The discharge portion 90 has a discharge tube 91 extending to the outside from this side surface. The discharge portion 90 may be provided on any outer surface of the first case 40 and the second case 50 other than the left side surface of the second case 50, as long as internal gas can efficiently be discharged to the outside. The present embodiment is not limited to including only one discharge portion 90 and may include a plurality thereof.

Gas is produced inside the battery cells 10 along with deterioration over time. If the pressure of the internal gas exceeds a predetermined value, the internal gas is released to the outside from the surrounding edges of the battery cells 10. The discharge portion 90 guides the internal gas released from the battery cells 10 through the discharge tube 91 to the outside of the battery pack 1.

The above battery pack 1 according to the third embodiment achieves similar effects to those described in the first and second embodiments. Additionally, the battery pack 1 according to the third embodiment increases safety by guiding the internal gas outside through the discharge portion 90. In other words, the battery pack 1 can improve product reliability.

It will be apparent to a person of ordinary skill in the art that the present disclosure can be embodied in forms other than the above embodiment without departing from the spirit or essential features of the present disclosure. Accordingly, the description above is only a non-limiting example. The scope of the present disclosure is defined not by the description above, but by the appended claims. Among all possible modifications, the modifications within the range of equivalents are to be considered encompassed by the claims.

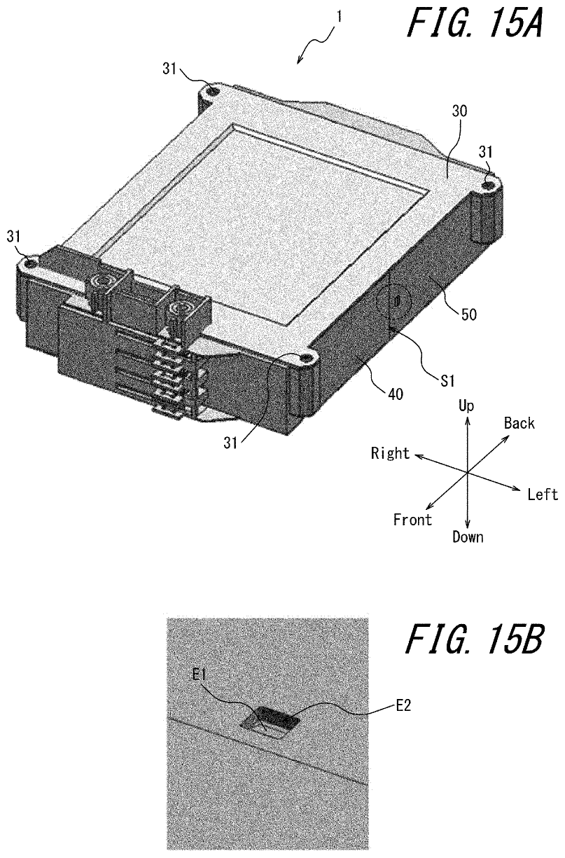

FIGS. 15A and 15B illustrate a fitting portion of the first case 40 and the second case 50. FIG. 15A is a perspective view illustrating the appearance of the battery pack 1. FIG. 15B illustrates an enlargement of the portion surrounded by a dashed line in FIG. 15A.

For example, the first case 40 and the second case 50 may be fit together with engaging claws E1 formed on the left and right side surfaces of one case and engaging holes E2 formed on the corresponding left and right side surfaces of the other case. The engaging claws E1 engage with the engaging holes E2 when the first case 40 and the second case 50 are fit together. The battery pack 1 is not limited to a configuration engaged by a claw and hole. For example, the first case 40 and the second case 50 may be fit together by arbitrary protrusions, which protrude from the respective left and right side surfaces, being clamped by an elastic member, such as a clip. The first case 40 and the second case 50 may be fit together by any fastening structure, such as screwing. In this way, the battery pack 1 may have any engaging structure that allows the first case 40 and the second case 50 to be fit together reliably. The battery pack 1 is therefore easy to assemble, which can contribute to improving product reliability.

The abutting portion 44 has been described as being provided only in the first case 40, but this example is not limiting. For example, the second case 50 may include an abutting portion. In this case, the abutting portion may be configured by at least one of the first inner wall 54a, the second inner wall 54b, and the third inner wall 54c. Both the first case 40 and the second case 50 may include an abutting portion.

The battery pack 1 need not include the tapered portions 45a and 55a as long as ease of insertion of the battery cells 10 into the first case 40 and the second case 50 can be secured.

The battery pack 1 is not limited to a configuration such that the guides 45 and 55 are independently provided. For example, the guides 45 and 55 may be omitted, and the battery pack 1 may be configured so that the first insulating portions 46a and 56a also serve as guides. In this case, the ease of insertion of the battery cells 10 can be improved by the first insulating portions 46a and 56a being provided with a tapered shape.

A restraining plate 30 may also be provided along with the opening O at the lower surface side of the battery cell assembly 100 in the battery pack 1. The battery cell assembly 100 is thereby sandwiched from both above and below by rigid restraining plates 30, further improving the pressure retention.

Similarly, an insulating sheet 20 may also be provided at the lower surface side of the battery cell assembly 100 in the battery pack 1. The electrical insulation in the battery pack 1 can thereby be further improved.

The number of battery cells 10 and the number of windows 42 and 52 are not limited to the above configurations. Any number of battery cells 10 may be included. The windows 42 and 52 may be provided in an appropriate form corresponding to the number of battery cells 10.

### REFERENCE SIGNS LIST

1 Battery pack
10, 10a, 10b, 10c, 10d, 10e, 10f Battery cell
11 Outer surface
12p, 12n Electrode tab
13 Outer surface
14 Exterior member
20 Insulating sheet
30 Restraining plate
31 Hole
32 Recess
40 First case
40a Bottom surface
41 Screw hole
42, 42a, 42b, 42c, 42d Window
421, 421a, 421b, 421c, 421d Window
422, 422a, 422b, 422c Window
43 Jig insertion hole
44 Abutting portion
44a First inner wall (inner wall)
44b Second inner wall
44c Third inner wall
45 Guide
45a Tapered portion
46a First insulating portion (insulating portion)
46b Second insulating portion
47, 47a, 47b, 47c, 47d Housing portion
471, 471a, 471b, 471c, 471d Housing portion
472, 472a, 472b, 472c Housing portion
50 Second case
51 Screw hole
52, 52a, 52b, 52c Window
53 Jig insertion hole
54a First inner wall (inner wall)
54b Second inner wall
54c Third inner wall
55 Guide
55a Tapered portion
56a First insulating portion (insulating portion)
56b Second insulating portion
57, 57a, 57b, 57c Housing portion
60a Total plus bus bar
60b Total minus bus bar
70a, 70b Jig
80 Body
80a Bottom surface
81 Support
81a Screw hole
90 Discharge portion
91 Discharge tube
100 Battery cell assembly
E1 Engaging claw
E2 Engaging hole
F Fixing portion Opening
S1 Connection surface
S2 Tip surface

1. A battery pack comprising a stacked plurality of battery cells housed between a first case and a second case;
wherein the battery cells each comprise an electrode tab protruding from an outer surface of an exterior member;
wherein tips of adjacent electrode tabs are connected by being bent in opposite directions to be folded and overlap with each other;
wherein the first case and the second case are aligned in a direction in which the electrode tab protrudes and are connected to each other;
wherein the exterior member of each battery cell is inserted in the first case, in the direction in which the electrode tab protrudes, and is supported by the first case;
wherein the first case comprises an inner wall intersecting the direction in which the electrode tab protrudes;
wherein the inner wall is positioned farther outward, at a folded and overlapping portion of the electrode tabs, than the tip of the electrode tab disposed at one side in a stacking direction of the battery cells and abuts against the tip of the electrode tab disposed at the other side in the stacking direction of the battery cells to regulate movement of the electrode tabs at the one side and the other side;
wherein the folded and overlapping portion of the electrode tabs is welded; and
wherein an opening is formed on the inner wall to expose a welding spot of the electrode tabs.

2. (canceled)

3. The battery pack of claim 1,
wherein the first case comprises a housing portion configured to house the electrode tab therein; and
wherein an insulating portion is provided between a pair of the electrode tabs that are connected to each other and the electrode tab of a battery cell, among the plurality of battery cells, adjacent to one electrode tab of the pair of the electrode tabs; and
wherein the insulating portion extends from the inner wall towards the exterior member of the battery cell.

4. The battery pack of claim 3,
wherein the insulating portion is formed to have a plate shape along the electrode tab; and
wherein the insulating portion is not disposed between the pair of the electrode tabs that are connected to each other.

5. The battery pack of claim 3, wherein a guide configured to guide the pair of the electrode tabs into the housing portion is formed on the insulating portion.

6. The battery pack of claim 5, wherein the guide is formed as a pair of ribs sandwiching the pair of the electrode tabs from both sides in the stacking direction of the battery cells;
wherein the guide comprises:
a constant portion connected to the inner wall and having a constant amount of protrusion; and
a tapered portion extending from the constant portion, and
wherein the tapered portion has a tapered shape such that the amount of protrusion decreases in a direction moving away from the inner wall, of the first case, that intersects the direction in which the electrode tab protrudes.

7. The battery pack of claim 3, wherein the battery cells provided with an insulating portion between the electrode tabs are connected to each other by electrode tabs of different polarity from a polarity of the electrode tabs with the insulating portion therebetween.

8. The battery pack of claim 7, wherein between the battery cells comprising the pair of electrode tabs connected to each other, an insulating portion is provided between the electrode tabs of different polarity from the polarity of the electrode tabs connected to each other.

9. The battery pack of claim 1, wherein the first case and the second case are made of a resin material or a metal material provided with an electrically insulating material on a surface thereof.
